(19) United States
(12) Patent Application Publication
(10) Pub. No.: US 2015/0075337 A1
(43) Pub. Date: Mar. 19, 2015

(54) Enviro-Pactor Plastic Water Bottle Wrench

(71) Applicant: Richard Allen Lee, Columbus, OH (US)

(72) Inventor: Richard Allen Lee, Columbus, OH (US)

(21) Appl. No.: 14/027,242

(22) Filed: Sep. 15, 2013

(51) Int. Cl. B25B 27/00

(52) U.S. Cl. CPC B25B 27/00
USPC 81/486

(57) ABSTRACT

Efficiently reduces plastic non-pressure rated water bottles to less than ¼ of their original inflated size. By means of rolling one up with a hand held tool to create recycle space. In addition the Enviropactor Wrench will also insert up to 10 plus Toilet Tissue/Paper Towel Tubes one inside the other in turn dramatically increasing your cardboard recycle area. It will make a huge difference in the recycle of plastic water bottles and household cardboards. I can put 60 inflated water bottles in a 13 gallon trash bag and if I use the Enviro-Pactor Plastic Water Bottle Wrench then I can put 420 plastic water bottles in the same size trash bag. Can be used indoors and outdoors under any human conditions. Can be used anywhere bottled water is used or drank. The more we use it the more we will benefit from it. The Enviro-Pactor Plastic Water Bottle Wrench is simple original, simple to use, environmentally friendly, fun.

### BACKGROUND

The Enviro-Pactor Plastic Water Bottle Wrench has been created specifically for reducing plastic non-pressure rated water bottles to less than ¼ of their original inflated size. (16, 20, 60 oz water bottles) By means of rolling one up with a hand held tool to create recycle space. This tool was developed during the holidays when the recycle trucks became delayed for pick up of our recycle bins. Our plastic recycle bins were overflowing mainly due to our purified empty non pressure/carbonated rated water bottles. After the prototype was used one time our recycle bin material became reduced and space created by 90%. All of our plastic recycle went in the container with ⅔'s of space remaining. At the time it was clear that the citizens of this country and around the world that recycles “NEEDS” this product for their convenience and for our environment.

### DETAILED DESCRIPTION

The Enviropactor Plastic Water Bottle Wrench works effortlessly and reduces plastic water bottles to ¼ of their original size by slipping it over a pinched lower portion of the bottle then rolled up tightly like a large key deflating then resealing the cap maintains the tight coil. My device runs on human power, consumes nothing and creates plastic recycle space wherever it's used. Pinch the bottle nearest to the bottom while creasing the plastic. Slide bottle into opening of the Enviro-Pactor Plastic Water Bottle Wrench all the way, until it stops. Put bottle in one hand and crank the wrench forward until bottle deflates and coils tightly. Reseal Cap and Pull the Enviro-Pactor Plastic Water Bottle Wrench Out! The keychain prototype Shaft 3″ Length, ⅜″ Diameter. Handle 1⅞″ Width Nylon Coated and 3/16″ Diameter. Look like a key. The stationary version is a little longer. Shaft is 6″ Length. Handle has 4″ Nylon Coated Handle. 1″ Diameter key ring for a chain swivel optional, ⅜″ Diameter. Looks like a “T” shaped tuning fork. Can be made from recycled plastic, metal, aluminum, gold, silver, carbon fiber, nylon and so on. Also can be in a variety of colors. MUST maintain smooth rolled edges to avoid cutting the plastic. Raised letters and/or numbers on the exterior of the shaft to leave an I.D. imprinted on the bottle when used. Such as Name, Patient Number, etc. Must maintain comfortable nylon coated handle at least 1⅞″ wide.

### SPECIFICATION

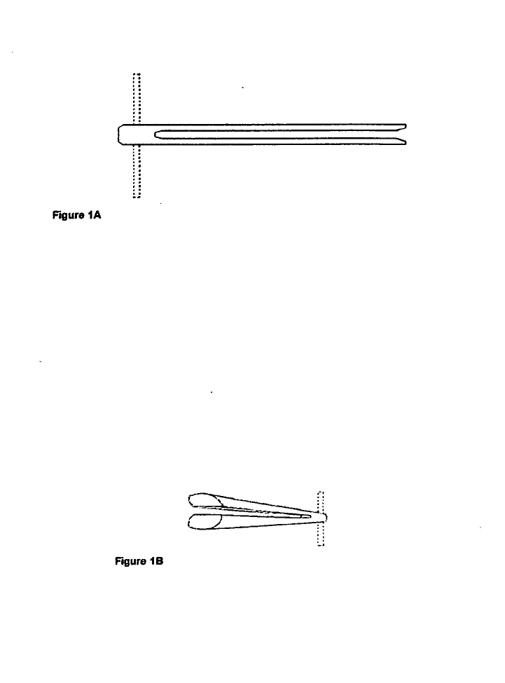

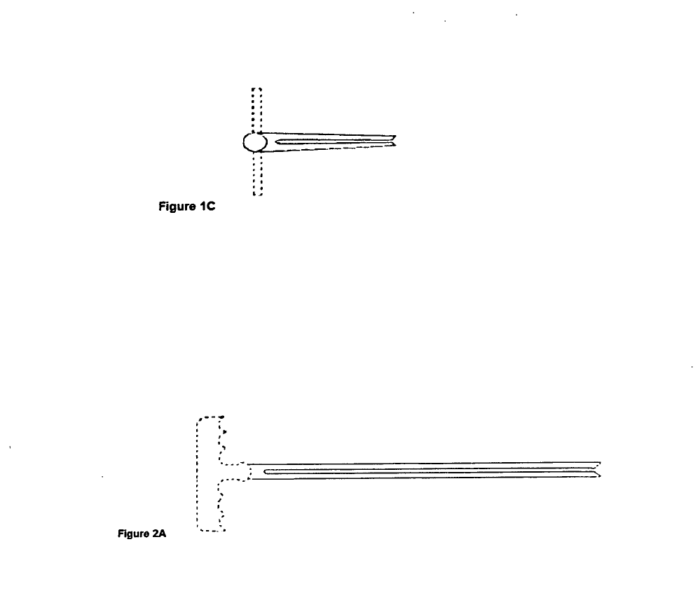

FIG. 1A

The Enviro-Pactor Plastic Water Bottle Wrench. Keychain version. A plastic water bottle compacting wrench by twisting and locking in vacuum with the bottle cap. Can be made from recycled plastic, metal, aluminum, gold, silver, carbon fiber, nylon and so on. Also can be in a variety of colors. Just MUST maintain smooth rolled edges to avoid cutting the plastic. Raised letters and/or numbers on the exterior of the shaft to leave an I.D. imprinted on the bottle when used. Such as Name, Patient Number, etc. Must also maintain comfortable nylon coated handle at least 1⅞″ wide.

FIG. 1B

Front view of the Enviro-Pactor Plastic Water Bottle Wrench. Shaft is 3″ length and ⅜″ Diameter. Handle is 1⅞″ Width Nylon coated and 3/16″ Diameter.

FIG. 1C

Rear view of the Enviro-Pactor Plastic Water Bottle Wrench.

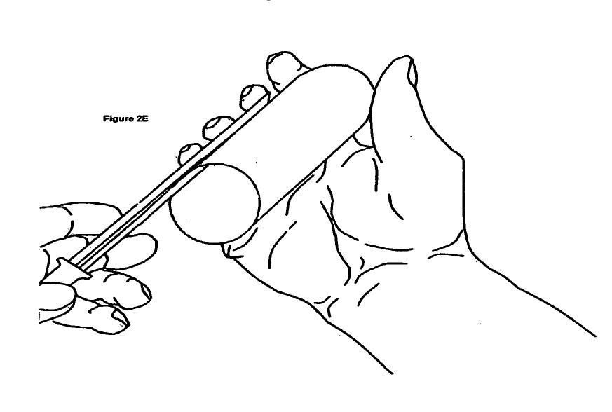

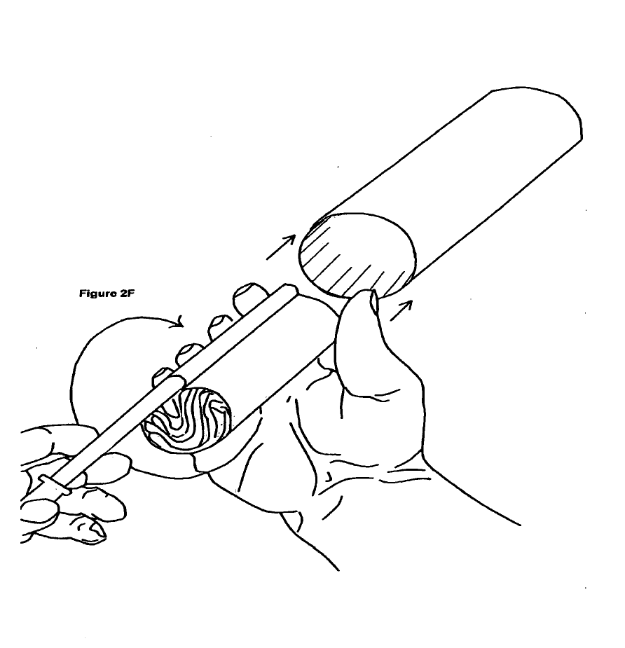

FIG. 2A

Top view of the Enviro-Pactor Plastic Water Bottle Wrench. Stationary Version. A bigger version of the Enviro-Pactor Plastic Water Bottle Wrench. Length is 6″ and the Diameter ⅜″ The handle is 4″ width nylon coated with a 1″ diameter key ring for a chain swivel optional and is also ⅜″ diameter.

FIG. 2E

Sliding the Enviro-Pactor Plastic Water Bottle Wrench over the tube.

FIG. 2F

Additional use of the Enviro-Pactor Plastic Water Bottle Wrench by slipping the Enviro-Pactor Plastic Bottle Wrench over the last tube inserted and turn clockwise ½ turn. This will decrease diameter compressing all the other tubes inside allowing you to slide another tube over 10 plus toilet tubes. Shows 9 in palm of hand and 1 more lined up to slide over the 9 tubes.

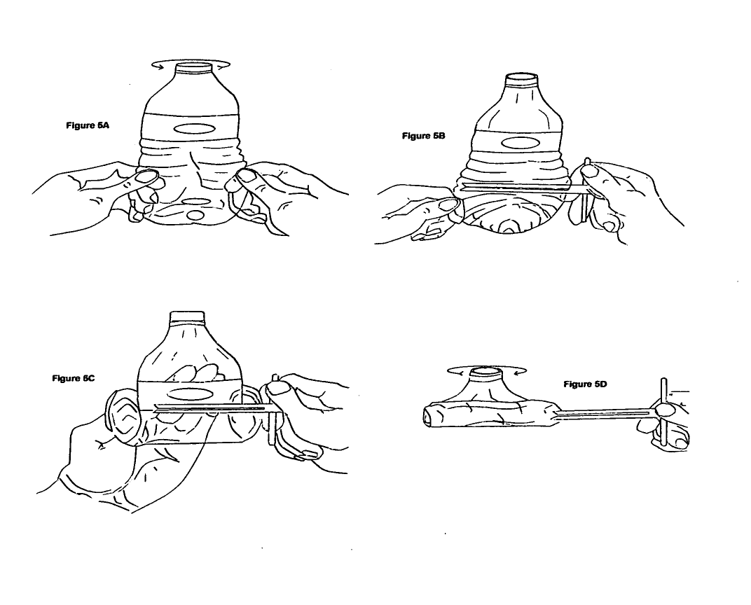

FIG. 5A

The first step on how the Enviro-Pactor Plastic Water Bottle Wrench works effortlessly and reduces plastic water bottles to ¼ of their original size. Pinch the bottle nearest the bottom while creasing the plastic.

FIG. 5B

The Second step on how the Enviro-Pactor Plastic Water Bottle Wrench works. Slide bottle into opening of the opening of the Enviro-Pactor all the way until it stops.

FIG. 5C

The Third step on how the Enviro-Pactor Plastic Water Bottle Wrench works. My device runs on human power, consumes nothing and creates plastic recycle space every time it's used. Put the bottle in one hand and crank the wrench forward until bottle deflates and coils tightly.

FIG. 5D

The fourth and final step on how the Enviro-Pactor Plastic Water Bottle Wrench works. Once bottle is coiled tightly and deflated, then reseal the cap and pull the Enviro-Pactor Plastic Water Bottle Wrench Out!

### DETAILED DESCRIPTION

The Enviropactor Plastic Water Bottle Wrench works effortlessly and reduces plastic water bottles to ¼ of their original size by slipping it over a pinched lower portion of the bottle then rolled up tightly like a large key deflating then resealing the cap maintains the tight coil. My device runs on human power, consumes nothing and creates plastic recycle space wherever it's used. Pinch the bottle nearest to the bottom while creasing the plastic (See FIG. 5A). Slide bottle into opening of The Enviro-Pactor Plastic Water Bottle Wrench all the way, until it stops. (See FIG. 5B) Put bottle in one hand and crank the wrench forward until bottle deflates and coils tightly. (See FIG. 5C) Reseal Cap and Pull the Enviro-Pactor Plastic Water Bottle Wrench Out! (See FIG. 5D) The keychain prototype Shaft 3″ Length, ⅜″ Diameter. Handle 1⅞″ Width Nylon Coated and 3/16″ Diameter. Look like a key. (See FIGS. 1A, 1B and 1C) The stationary version is a little longer. Shaft is 6″ Length. Handle has 4″ Nylon Coated Handle. 1″ Diameter key ring for a chain swivel optional, ⅜″ Diameter. Looks like a “T” shaped tuning fork. (See FIG. 2A) Can be made from recycled plastic, metal, aluminum, gold, silver, carbon fiber, nylon and so on. Also can be in a variety of colors. MUST maintain smooth rolled edges to avoid cutting the plastic. Raised letters and/or numbers on the exterior of the shaft to leave an I.D. imprinted on the bottle when used. Such as Name, Patient Number, etc. Must maintain comfortable nylon coated handle at least 1⅞″ wide.

1. The Enviro-Pactor Plastic Water Bottle Wrench can reduce 16-20 oz non-pressure rated water bottles and some 20 oz pressure rated soda bottles less then ¼ of their original size to pocket size portions after deflating by means of rolling by hand by each individual in addition many pressed cardboards can also be reduces by 85% such as toilet tissue tubes, wax paper tubes, paper towel tubes, snack boxes, pop cartons, and so on if you can roll it up it will reduce it toilet tissue tubes can be compacted 10 to 1 a 90% reduction and become valuable storage for other pressed cardboards, it creates recycle space for plastic water bottles and household cardboards while it waits in our world for recycle.
